(19) United States
(12) Patent Application Publication
(10) Pub. No.: US 2008/0062397 A1
(43) Pub. Date: Mar. 13, 2008

(54) Photolithography Apparatus Having Mirror for Correcting Aberrations in Optical Illumination System and Mirror Having Aberration Correcting Part

(76) Inventors: Dong-seok Nam, Yongin-si (KR); Seong-woon Choi, Suwon-si (KR)

Correspondence Address: F. CHAU & ASSOCIATES, LLC, 130 WOODBURY ROAD, WOODBURY, NY, 11797, US

(21) Appl. No.: 11/844,094

(22) Filed: Aug. 23, 2007

(30) Foreign Application Priority Data
Sep. 8, 2006 (KR) 10-2006-0086919

(51) Int. Cl. G03B 27/70; G02B 5/08

(52) U.S. Cl. 355/66; 359/838; 359/846

(57) ABSTRACT

A photolithography apparatus includes an optical illumination system. The optical illumination system includes a light source, an illumination system, a photomask, and a projection system. The light source generates light. The illumination system transmits the light generated by the light source. The photomask receives the light transmitted by the illumination system and forms an optical pattern image. The projection system transmits the optical pattern image formed by the photomask to a substrate surface. Either one of the illumination system and the projection system includes at least one mirror for correcting aberrations.

### CROSS REFERENCE TO RELATED APPLICATION

This application claims priority from Korean Patent Application No. 10-2006-0086919 filed on Sep. 8, 2006, in the Korean Intellectual Property Office, the disclosure of which is incorporated herein by reference in its entirety.

### BACKGROUND OF THE INVENTION

1. Field of the Invention

The present invention relates, in general, to a method of correcting aberrations in an optical illumination system for a photolithography apparatus used to manufacture semiconductor devices and, more particularly, to a method of correcting aberrations in an optical illumination system for a photolithography apparatus, used to manufacture semiconductor devices, using an aberration correcting part formed in a mirror.

2. Description of Related Art

With high integration of semiconductor devices, phenomena which were considered to be insignificant in the past have become important factors. For example, fine defects in wafers, the purity of a photo resist or cleaning solution, the content of impurities contained in a formed layer, finer process control, etc. have become important. Another important factor is a photolithography field. The photolithography field, may be affected by, for example, precision of the optical pattern of a photomask, etc., with errors related to aberrations in an optical illumination system for a photolithography apparatus being an important problem that has appeared in the manufacture of high integration semiconductor devices. Such aberrations in optical illumination systems are common, and may greatly influence the formation of patterns of a semiconductor device.

Such aberrations occurring in optical illumination systems when high integration semiconductor devices are manufactured may be as small as several nm or below, or even several Å or below, thus these aberrations need to be kept fine. Further, even where a photolithography apparatus in which no aberrations formed during an initial manufacturing process is used, because the illumination method used in the photolithography apparatus varies, unpredictable aberrations may occur. For example, astigmatisms may be formed, or an optical image may be distorted according to variation in the size of a pupil area. Further, a coma aberration, etc. may occur when an Off Axis Illumination (OAI) method is used. Other aberrations may be formed when the photolithography apparatus is used. If an aberration phenomenon occurs, aberrations in the optical illumination system for the photolithography apparatus cannot be corrected once the optical illumination system has been designed. Instead, a new photolithography apparatus is needed, or an optical illumination system needs to be redesigned. Because photolithography equipment an expensive component of the semiconductor manufacturing equipment.

Therefore a need exists for a method of correcting aberrations in an optical illumination system for a previously completed photolithography apparatus and utilizing the aberration-corrected optical illumination system is provided.

### SUMMARY OF THE INVENTION

In accordance with an embodiment of the present invention a photolithography apparatus comprises an optical illumination system comprising, a light source generating light, an illumination system transmitting the light generated by the light source, a photomask receiving the light transmitted by the illumination system and forming an optical pattern image, and a projection system transmitting the optical pattern image formed by the photomask to a pupil plane, and at least one mirror correcting an aberration in the optical illumination system.

In accordance with another embodiment of the present invention a photolithography apparatus comprises an optical illumination system comprising a light source, a plurality of lenses transmitting light generated by the light source, and a plurality of mirrors changing a traveling direction of the light generated by the light source, and at least one mirror correcting an aberration of the optical illumination system.

In accordance with a further embodiment of the present invention a mirror for correcting an aberration comprises a substrate, a reflective layer formed on one surface of the substrate, and an aberration correcting part formed in the substrate.

### BRIEF DESCRIPTION OF THE DRAWINGS

The present invention will be more clearly understood from the following detailed description taken in conjunction with the accompanying drawings, in which:

FIG. 1 is a diagram schematically showing a reflective optical illumination system for a photolithography apparatus according to an embodiment of the present invention;

FIGS. 2A to 2C are diagrams schematically showing a mirror before an aberration in the reflective optical illumination system is corrected, and mirrors for correcting the aberration in the reflective optical illumination system according to embodiments of the present invention;

FIGS. 3A to 3C are diagrams schematically showing a mirror before another kind of aberration in the reflective optical illumination system is corrected, and mirrors for correcting that kind of aberration in the reflective optical illumination system according to other embodiments of the present invention;

FIGS. 4A and 4B are diagrams schematically showing a mirror before a composite aberration in the reflective optical illumination system is corrected, and a mirror for correcting the aberration in the reflective optical illumination system according to another embodiment of the present invention;

FIGS. 4C and 4D are diagrams schematically showing a mirror having another kind of composite aberration and a mirror for correcting that kind of aberration according to yet another embodiment of the present invention;

FIGS. 5A to 5D are diagrams showing examples in which the technical conception of the present invention is applied to a flat mirror;

FIGS. 6A and 6B are diagrams schematically showing a projective optical illumination system for a photolithography apparatus for correcting aberrations according to embodiments of the present invention;

FIG. 7 is a diagram schematically showing a method of forming aberration correcting parts in a mirror substrate according to various embodiments of the present invention; and

FIG. 8 is a diagram showing a laser for forming aberration correcting parts according to various embodiments of the present invention.

### DETAILED DESCRIPTION OF EXEMPLARY EMBODIMENTS

The present invention and methods of achieving them will be apparent with reference to embodiments described in detail in conjunction with the accompanying drawings. However, the present invention is not limited to embodiments disclosed herein, but may be implemented in various forms. Embodiments are provided to complete the disclosure of the present invention and to inform those skilled in the art of the details of the present invention. The present invention is defined only by the scope of the accompanying claims. Hereinafter, reference now should be made to the drawings, in which the same reference numerals are used throughout the different drawings to designate the same or similar components.

Embodiments disclosed in the present specification will be described with reference to plan views and sectional views, which are schematic diagrams of the present invention. Therefore, the forms in the illustration can be modified depending on manufacturing technology and/or tolerance. Therefore, embodiments of the present invention also include variation in shape, generated depending on a manufacturing process, without being limited to specific illustrated forms. Further, regions illustrated in the drawings have schematic attributes, and the shapes of the regions illustrated in the drawings are only used to exemplify the specific shape of a device region, but are not intended to limit the scope of the present invention.

The term “aberration” used in the present specification inclusively means various kinds of aberrations that may occur in an optical illumination system for a photolithography apparatus.

Hereinafter, an optical illumination system for a photolithography apparatus for correcting aberrations and a mirror for correcting aberrations in the optical illumination system according to an embodiment of the present invention will be described in detail with reference to the attached drawings.

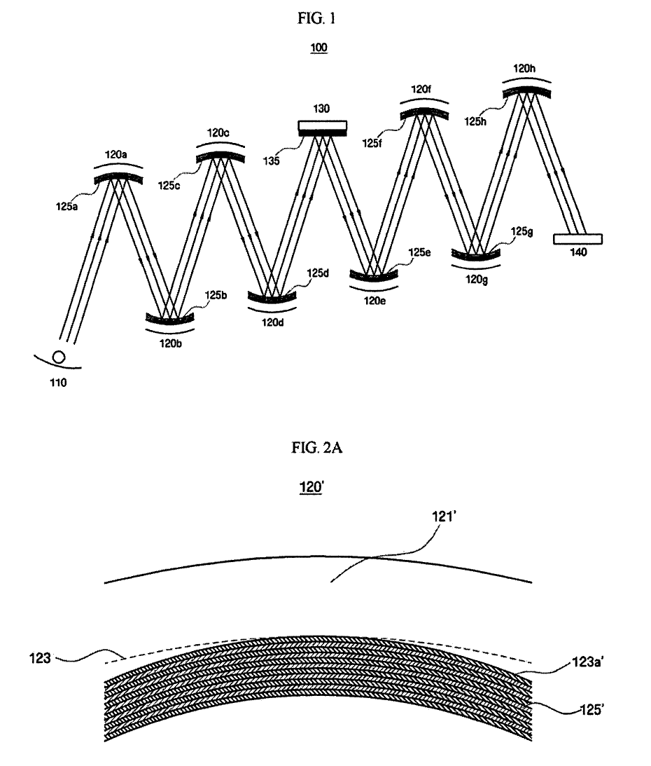

FIG. 1 is a diagram schematically showing a reflective optical illumination system for a photolithography apparatus according to an embodiment of the present invention.

Referring to FIG. 1, a reflective optical illumination system 100 for a photolithography apparatus according to an embodiment of the present invention includes a light source 110, illumination mirrors 120a to 120d for receiving light generated by the light source 110, and reflecting and transmitting the received light, a photomask 130 for receiving the reflected light from the illumination mirrors 120a to 120d and reflecting an optical pattern image, and projection mirrors 120e to 120h for transmitting the optical pattern image reflected from the photomask 130 to a pupil plane 140. In this case, at least one mirror for correcting aberrations in the optical illumination system is included in the illumination mirrors 120a to 120d, or the projection mirrors 120e to 120h. According to an embodiment of the present invention, the mirrors 120a to 120d placed in an optical path ranging from the light source 110 to the photomask 130 are designated as illumination mirrors. The mirrors 120e to 120h placed in an optical path ranging from the photomask 130 to the pupil plane 140 are projection mirrors. In the drawing, four illumination mirrors 120a to 120d and four projection mirrors 120e to 120h are shown, but these are only illustrated as examples to facilitate the understanding of the technical conception of the present invention. In practice, the reflective optical illumination system 100 for the photolithography apparatus may include more mirrors, or various kinds thereof.

The light source 110 is a part for generating light used in the reflective optical illumination system 100. In an embodiment of the present invention, the light source 110 may generate, for example, Extreme Ultra Violet (EUV) light. EUV light is ultrahigh frequency light having a wavelength of about 13.5 nm. Since EUV light has a high absorption in media such as air a reflective optical illumination system 100 using mirrors needs to be implemented.

The photomask 130 is provided to transmit an optical pattern image to the pupil plane 140. On the surface of the photomask 130, an optical pattern 135 can be formed. The substrate of the photomask 130 can be made of quartz, and the optical pattern 135 is formed on one surface of the substrate. The optical pattern 135 is a reflective pattern for reflecting light, and can be formed by alternately stacking a plurality of unit reflective layers on a quartz substrate. Accordingly to an embodiment of the present invention, several tens of pairs of a silicon layer and a molybdenum layer are alternately stacked with each other, thus the optical pattern 135 can be formed. According to an embodiment of the present invention, a pair of unit reflective layers can be formed such that the total thickness of a silicon layer and a molybdenum layer account for approximately half of the wavelength of the EUV light. For example, the silicon layer is formed to a thickness of 4 to 5 nm, and the molybdenum layer is formed to a thickness of 2 to 3 nm, thus a combined thickness thereof can be about 6.5 to 7 nm. Each of the silicon layer and the molybdenum layer can be formed using an atomic layered deposition method. Further, the optical pattern can be formed in such a way that a silicon layer, a molybdenum layer, and a boron-carbon compound layer are alternately stacked with each other. According to an embodiment of the present invention, the case where a silicon layer and a molybdenum layer are alternately stacked is taken as an example. On the reflective layer, a capping layer for protecting the reflective layer from physical and mechanical damage can be formed. For example, a silicon oxide layer can be formed as the capping layer. The optical pattern image of the optical pattern 135 can be formed by forming a light absorption layer, which does not reflect light, above or below the reflective layer for reflecting light. For example, a metal layer, including chrome, aluminum or tantalum, and a metal oxide layer are formed on the reflective layer in order to prevent light from being reflected, thus the optical pattern image can be formed. That is, the optical pattern 135 can be formed to selectively include a reflective layer, a capping layer, and a light absorption layer. Further, the light absorption layer can be formed first, and the reflective layer can be formed on the light absorption layer, thus the optical pattern 135 can be formed.

The pupil plane 140 is the plane on which the optical pattern image, formed by the optical pattern 135 of the photomask 130, is projected.

The illumination mirrors 120a to 120d and the projection mirrors 120e to 120h reflect light. The mirrors 120a to 120h are made of quartz, and include reflective layers 125a to 125h on first sides of the substrates thereof to reflect light. The reflective layer 125 can be formed to have the same features as the reflective layer of the optical pattern 135 of the photomask 130. The mirrors 120a to 120h can have a concave dish shape, or can have a flat shape. In the drawing, for easy understanding of the technical conception of the present invention, all of the mirrors 120a to 120h are illustrated as having the same shape, for example, a concave dish shape. A detailed description of the mirrors 120a to 120h will be made later.

The reflective optical illumination system 100 according to an embodiment of the present invention includes at least one mirror for correcting aberrations thereof. The structure of the mirror for correcting aberrations in the optical illumination system 100 and a method of correcting aberrations using the mirror will be described in detail later.

In particular, a mirror for correcting aberrations in the reflective optical illumination system 100 can be placed in a conjugate plane corresponding to the pupil plane 140. In the reflective optical illumination system 100, light generated from the light source 110 is radiated onto the pupil plane 140 through the plurality of mirrors 120a to 120h and the photomask 130. At this time, light passes through various paths depending on respective locations of the plurality of mirrors 120a to 120h and the photomask 130. That is, the mirrors 120a to 120h may not cause the same magnification or form the same aerial image as the photomask 130 or the pupil plane 140. Of the plurality of mirrors 120a to 120h, one or more mirrors can cause the same magnification or form the same aerial image as the photomask 130 or the pupil plane 140. In one case, there is no mirror actually having the same magnification or aerial image, but only a virtual plane may exist. Such a plane is designated as a conjugate plane. The conjugate plane is arbitrarily created by a designer for designing an optical illumination system for each photolithography apparatus. Therefore, since the designation of specific components in the drawing may cause the technical conception of the present invention to be misunderstood, specific components are not designated. Consequently, in the drawings, the conjugate plane may be one or more of the various mirrors 120a to 120h. Therefore, if any one of the mirrors 120a to 120h shown in the drawing is assumed to be a mirror corresponding to the conjugate plane, the technical conception of the present invention can be understood.

According to an embodiment of the present invention, in the reflective optical illumination system 100 for the photolithography apparatus, it may be assumed that one or more of the mirrors 120a to 120h corresponds to the conjugate plane. Further, mirrors 120a to 120h corresponding to the conjugate plane can be the mirrors 120a to 120h for correcting aberrations in the reflective optical illumination system 100. That is, the mirrors 120a to 120h for correcting aberrations in the reflective optical illumination system 100 can be placed in the conjugate plane of the reflective optical illumination system 100. According to an embodiment of the present invention, the case where mirrors 120a to 120h, each having a concave dish-shaped surface, are used for the conjugate plane is illustrated by example, but mirrors each having a planar surface can also be used. The mirrors each having a planar surface will be described later.

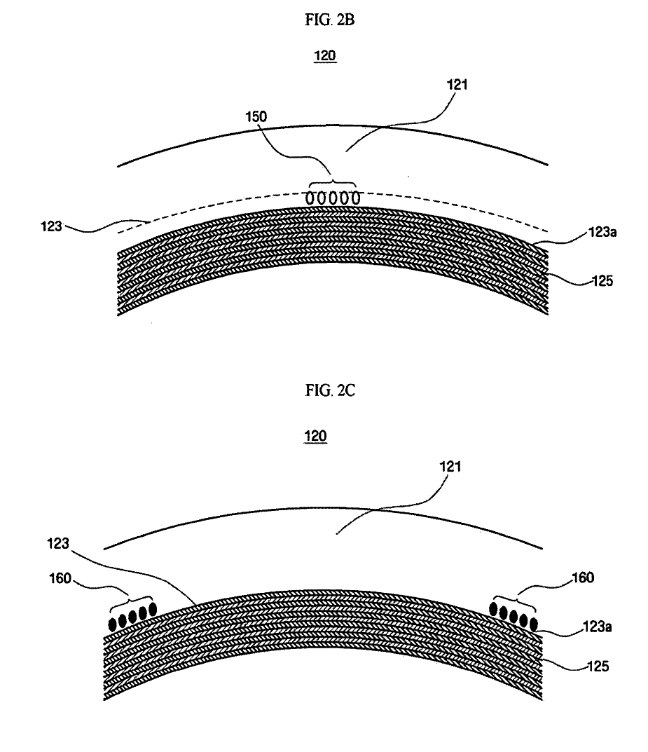

FIGS. 2A to 2C are diagrams schematically showing a mirror before an aberration in the reflective optical illumination system is corrected, and mirrors for correcting the aberration in the reflective optical illumination system according to embodiments of the present invention.

Referring to FIG. 2A, a mirror 120′ before an aberration in the reflective optical illumination system 100 is corrected is constructed so that a reflective layer 125′ is formed on the mirror surface 123a′ of a mirror substrate 121′, and the mirror surface 123a′ has a shape different from the surface 123 of the reflective optical illumination system 100 having no aberrations. In detail, the case of FIG. 2A can be understood to be the case where the mirror surface 123a′ itself may have a shape having no aberrations, but the reflective optical illumination system 100 has an aberration, so that the mirror surface 123a′ needs to be changed to the surface 123 of the reflective optical illumination system 100 having no aberrations and thus the aberration in the reflective optical illumination system 100 is corrected. In particular, the center portion of the mirror surface 123a′ can be understood to be coincident with that of the surface 123 of the reflective optical illumination system 100 having no aberrations, but the side portions of the mirror surface 123a′ protrude from that of the surface 123 of the reflective optical illumination system 100 having no aberrations.

Further, the case of FIG. 2A can be understood to be the case where the mirror 120′ itself has an aberration. If the mirror itself has an aberration, it can be understood that, since the mirror surface 123a′ has an aberration, it needs to be corrected to be a surface 123 having no aberrations. That is, the mirror 120′ of FIG. 2A can be understood to be a mirror 120′ that can be modified to correct aberrations in the reflective optical illumination system 100, and/or correct aberrations in itself.

Referring to FIG. 2B, a mirror 120 for correcting an aberration in the reflective optical illumination system 100 according to an embodiment of the present invention has a structure in which a mirror surface 123a is parallel to the surface 123 of the reflective optical illumination system 100 having no aberrations, compared to the mirror 120′ of FIG. 2A. In detail, expansion aberration correcting parts 150 are formed in the inside of a mirror substrate 121, so that the mirror surface 123a′ before an aberration in the reflective optical illumination system 100 is corrected is formed to be parallel to the mirror surface 123 of the reflective optical illumination system 100 having no aberrations. When the mirror surface 123a becomes parallel to the surface 123 of the reflective optical illumination system 100 having no aberrations, the aberration in the reflective optical illumination system 100 is corrected if the mirror surface 123a is caused to be coincident with the surface 123 of the reflective optical illumination system 100 having no aberrations by adjusting the location of the mirror 120 upwards and downwards, or forwards and backwards. The expansion aberration correcting parts 150 are locally formed in the mirror substrate 121, thus locally expanding the mirror substrate 121. The expansion aberration correcting parts 150 can be operated so that, for example, as the density thereof locally decreases, expansion stress in the mirror substrate 121 can be generated. The expansion stress can locally expand the volume of the mirror substrate 121. That is, the volume of the mirror substrate 121 is varied to cause the mirror surface 123a to be parallel to the surface 123 of the reflective optical illumination system 100 having no aberrations, thus correcting aberrations in the reflective optical illumination system 100. The expansion aberration correcting parts 150 can be formed to be close to the surface of the mirror substrate 121 on which the reflective layer 125 is formed. The expansion aberration correcting parts 150 can be formed by locally radiating a laser into the mirror substrate 121. The method of forming the expansion aberration correcting parts 150 will be described later.

Further, it can be understood that the mirror 120 may be modified to correct aberrations. It can be seen that the mirror surface 123a′ having its own aberrations has been corrected to be the mirror surface 123 having no aberrations because the expansion aberration correcting parts 150 are formed in the mirror surface 121. It can be seen that aberrations in the reflective optical illumination system 100 have been corrected, or that aberrations in the mirror 120 itself have been corrected.

Referring to FIG. 2C, a mirror 120 for correcting an aberration in the reflective optical illumination system 100 according to a further embodiment of the present invention has a structure in which a mirror surface 123a is coincident with the surface 123 of the reflective optical illumination system 100 having no aberrations, compared to the mirror 120′ of FIG. 2A. In detail, contraction aberration correcting parts 160 are formed in the mirror substrate 121, so that the mirror surface 123a′, before an aberration in the reflective optical illumination system 100 is corrected, and formed to be coincident to the mirror surface 123 of the reflective optical illumination system 100 having no aberrations. The contraction aberration correcting parts 160 can be locally formed in the mirror substrate 121, thus locally contracting the mirror substrate 121. The contraction aberration correcting parts 160 can be operated so that, for example, as the density thereof locally increases, contraction stress in the mirror substrate 121 can be generated, and such contraction stress can locally contract the volume of the mirror substrate 121. That is, the volume of the mirror substrate 121 is varied, so that the mirror surface 123a is caused to be coincident with the surface 123 of the reflective optical illumination system 100 having no aberrations, thus correcting aberrations in the reflective optical illumination system 100. The contraction aberration correcting parts 160 may be formed to be close to the surface of the mirror substrate 121 on which the reflective layer 125 is formed. The contraction aberration correcting parts 160 can be formed by locally radiating a laser into the mirror substrate 121. The method of forming the contraction aberration correcting parts 150 will be described later.

Further, it can also be understood that the mirror may be modified to correct aberrations. It can be seen that the mirror surface 123a′ having its own aberrations will have been corrected to be the mirror surface 123 having no aberrations because the contraction aberration correcting parts 160 are formed in the mirror surface 121. It can be seen that aberrations in the reflective optical illumination system 100 have been corrected, or that aberrations in the mirror 120 itself have been corrected.

In FIGS. 2B and 2C, the case where the expansion aberration correcting parts 150 are formed and correction is performed so that the mirror surface 123a is parallel to the surface 123 of the reflective optical illumination system 100 having no aberrations is illustrated, but correction can alternatively be performed so that the mirror surface 123a is coincident with the surface 123 having no aberrations. Further, the case where the contraction aberration correcting parts 160 are formed and correction is performed so that the mirror surface 123a is coincident with the surface 123 of the reflective optical illumination system 100 having no aberration is illustrated, but correction can alternatively be performed so that the mirror surface 123a is parallel to the surface 123. The expansion aberration correcting parts 150 and the contraction aberration correcting parts 160 can be flexibly applied in cases where aberrations are present.

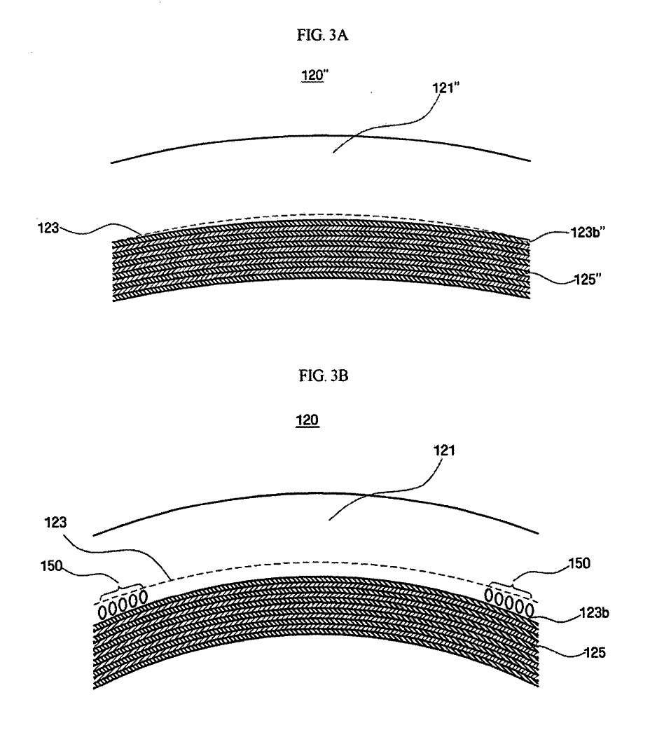

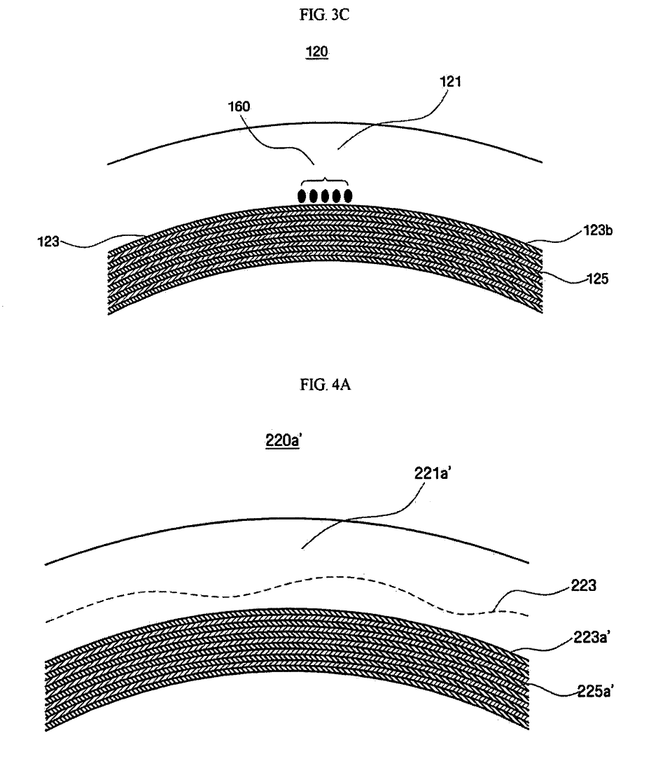

FIGS. 3A to 3C are diagrams schematically showing a mirror before an aberration in the reflective optical illumination system is corrected, and mirrors for correcting that kind of aberration in the reflective optical illumination system according to other embodiments of the present invention.

Referring to FIG. 3A, a mirror 120″ before the aberration in the reflective optical illumination system 100 is corrected has a structure in which a reflective layer 125″ is formed on the mirror surface 123b″ of a mirror substrate 121″, and the mirror surface 123b″ has a shape different from the surface 123 of the reflective optical illumination system 100 having no aberrations. In detail, the case of FIG. 3A can be understood to be the case where the mirror surface 123b″ itself has a shape having no aberrations, but the reflective optical illumination system 100 has an aberration, so that the mirror surface 123b″ needs to be changed to be coincident with the surface 123 of the reflective optical illumination system 100 having no aberration, and thus aberrations in the reflective optical illumination system 100 need to be corrected. In particular, it can be understood that the side portions of the mirror surface 123b″ are coincident with those of the surface 123 of the reflective optical illumination system 100 having no aberrations, but the center portion of the mirror surface 123b″ protrudes from the surface 123 of the reflective optical illumination system 100 having no aberrations.

Further, it can be seen that the mirror 120″ itself has aberrations. If the mirror 120″ itself has aberrations, the mirror surface 123b″ has an aberration, thus the mirror surface 123b″ needs to be corrected to be coincident with the surface 123 having no aberration. That is, the mirror 120″ of FIG. 3A can be understood to be a mirror 120″ that may be modified to correct aberrations in the reflective optical illumination system 100 and/or correct aberrations in itself.

Referring to FIG. 3B, a mirror 120 for correcting an aberration in the reflective optical illumination system 100 according to yet another embodiment of the present invention has a structure in which a mirror surface 123b is parallel to the surface 123 of the reflective optical illumination system 100 having no aberrations, compared to the mirror 120″ shown in FIG. 3A. In detail, expansion aberration correcting parts 150 are formed in a mirror substrate 121, thus the mirror surface 123b′ before an aberration in the reflective optical illumination system 100 is corrected is formed to be parallel to the mirror surface 123 of the reflective optical illumination system 100 having no aberrations. If the mirror surface 123b becomes parallel to the surface 123 of the reflective optical illumination system 100 having no aberrations, the aberration in the reflective optical illumination system 100 is corrected if the mirror surface 123b is caused to be coincident with the surface 123 of the reflective optical illumination system 100 having no aberrations by adjusting the location of the mirror 120 upwards and downwards or forwards and backwards. The expansion aberration correcting parts 150 are locally formed in the mirror substrate 121, thus locally expanding the mirror substrate 121.

Further, it can also be understood that the mirror 120 will have corrected its own aberrations by itself. It can be understood that the mirror surface 123b″ having its own aberrations has been corrected to be the mirror surface 123 having no aberrations because the expansion aberration correcting parts 150 are formed in the mirror surface 121. That is, it can be understood that aberrations in the reflective optical illumination system 100 have been corrected, or aberrations in the mirror 120 itself have been corrected.

Referring to FIG. 3C, a mirror 120 for correcting an aberration in the reflective optical illumination system 100 according to still another embodiment of the present invention has a structure in which a mirror surface 123b is coincident with the surface 123 of the reflective optical illumination system 100 having no aberrations, compared to the mirror 120″ of FIG. 3A. In detail, contraction aberration correcting parts 160 are formed in the mirror substrate 121, so that the mirror surface 123b″, before an aberration in the reflective optical illumination system 100 is corrected, is formed to be coincident with the mirror surface 123 of the reflective optical illumination system 100 having no aberrations. The contraction aberration correcting parts 160 are locally formed in the mirror substrate 121, thus locally contracting the mirror substrate 121. The contraction aberration correcting parts 160 can be operated so that, for example, as the density thereof locally increases, contraction stress in the mirror substrate 121 can be generated, and such contraction stress can locally contract the volume of the mirror substrate 121. That is, the volume of the mirror substrate 121 is varied, so that the mirror surface 123b is caused to be coincident with the surface 123 of the reflective optical illumination system 100 having no aberrations, thus aberrations in the reflective optical illumination system 100 can be corrected.

Further, it can also be understood that the mirror 120 will have corrected its own aberrations by itself. It can be understood that the mirror surface 123b″ having its own aberrations has been corrected to be the mirror surface 123 having no aberrations because the contraction aberration correcting parts 160 are formed in the mirror surface 121. That is, it can be understood that aberrations in the reflective optical illumination system 100 have been corrected, or aberrations in the mirror 120 itself have been corrected.

In FIGS. 3B and 3C, the case where the expansion aberration correcting parts 150 are formed and correction is performed so that the mirror surface 123b is parallel to the surface 123 of the reflective optical illumination system 100 having no aberrations is illustrated, but correction can alternatively be performed so that the mirror surface 123b is coincident with the surface 123 having no aberrations. Further, the case where the contraction aberration correcting parts 160 are formed and correction is performed so that the mirror surface 123b is coincident with the surface 123 of the reflective optical illumination system 100 having no aberrations is described, but correction can alternatively be performed so that the mirror surface 123b is parallel to the surface 123. That is, the expansion aberration correcting parts 150 and the contraction aberration correcting parts 160 can be flexibly applied in cases where aberrations are present.

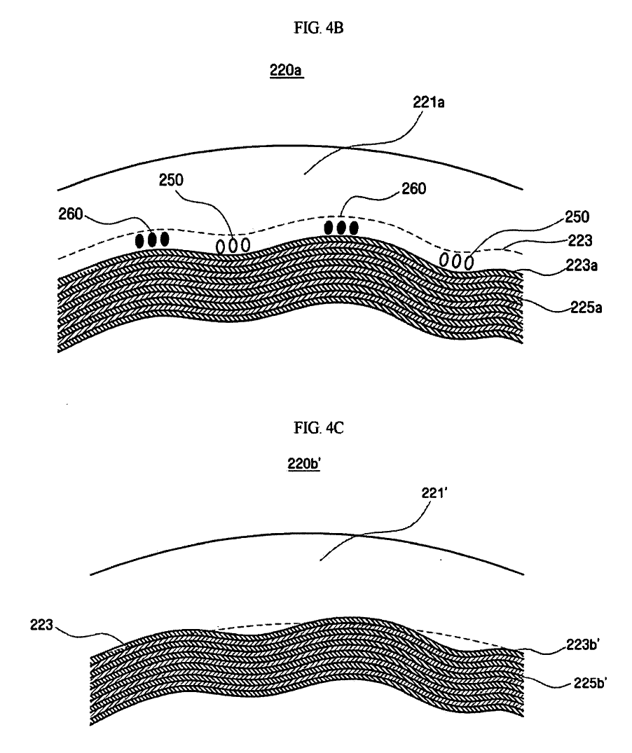

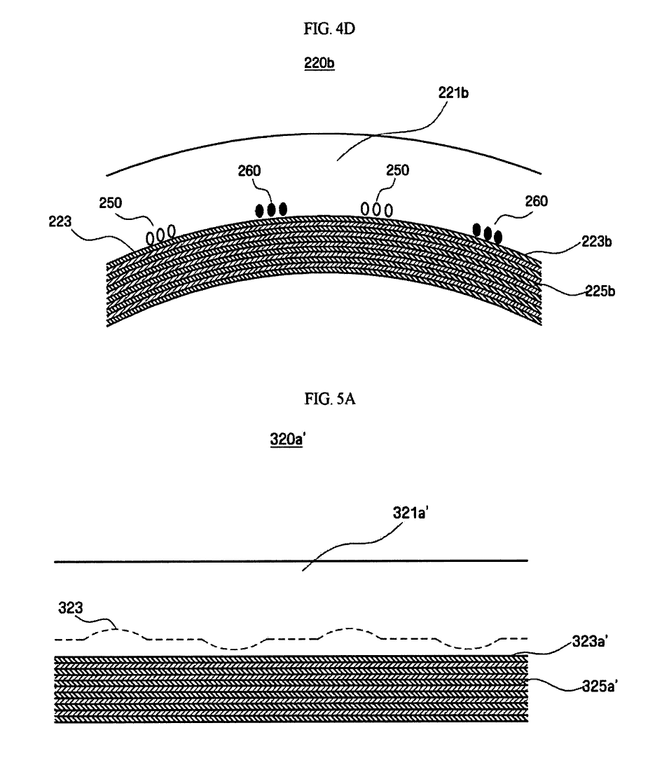

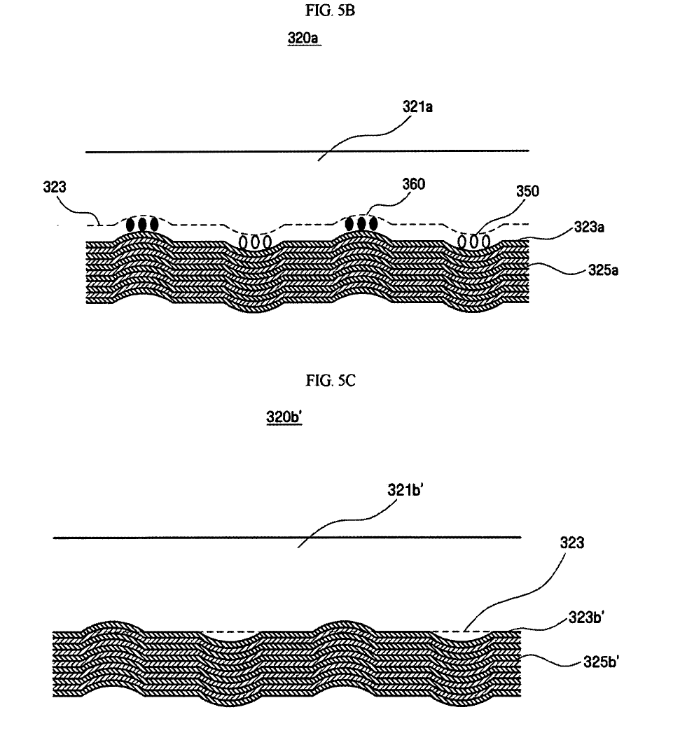

FIGS. 4A and 4B are diagrams schematically showing a mirror before a composite aberration in the reflective optical illumination system is corrected, and a mirror for correcting the aberration in the reflective optical illumination system, according to still another embodiment of the present invention.

Referring to FIG. 4A, a mirror 200′ before a composite aberration in the reflective optical illumination system 100 is corrected is constructed so that a reflective layer 225a′ is formed on the mirror surface 223a′ of a mirror substrate 221a′, and the mirror surface 223a′ has a shape different from that of the mirror surface 223 of the reflective optical illumination system 100 having no aberrations. In detail, the case of FIG. 4A can be understood to be a case where the mirror surface 223a′ itself may have a shape having no aberrations, but, when the reflective optical illumination system 100 has its own aberrations, as shown in FIGS. 2A and 3A, or other kinds of aberrations, the mirror surface 223a′ needs to be made coincident with the surface 223 of the reflective optical illumination system 100 having no aberrations, and thus the composite aberration in the reflective optical illumination system 100 needs to be corrected.

Referring to FIG. 4B, the mirror 220a for correcting a composite aberration in the reflective optical illumination system 100 according to still another embodiment of the present invention has a structure in which expansion aberration correcting parts 250 and contraction aberration correcting parts 260 are formed at various locations in the mirror substrate 221a, thus the mirror surface 223a is parallel to the mirror surface 223 of the reflective optical illumination system 100 having no aberrations. As another method, the mirror surface 223a may be coincident with the mirror surface 223 of the reflective optical illumination system 100 having no aberrations. In detail, the expansion aberration correcting parts 250 formed in the mirror substrate 221a locally expand the volume of the mirror substrate 221a, thus correcting the mirror surface 223a to make it coincident with the mirror surface 223 of the reflective optical illumination system 100 having no aberrations. The contraction aberration correcting parts 260 locally contract the volume of the mirror substrate 221a, thus correcting the mirror surface 223a to make it coincident with the mirror surface 223 of the reflective optical illumination system 100 having no aberrations. In the drawing, an example in which the surface 223 of the reflective optical illumination system 100 having no aberrations is parallel to the corrected mirror surface 223a is illustrated, but such an example is shown to facilitate the understanding of the technical conception of the present invention. In practice, the surface 223 of the reflective optical illumination system 100 having no aberrations can be coincident with the corrected mirror surface 223a.

FIGS. 4C and 4D are diagrams schematically showing a mirror having another kind of composite aberration and a mirror for correcting that kind of aberration according to still another embodiment of the present invention.

Referring to FIG. 4C, a mirror 220b′ having another kind of aberration is constructed so that a reflective layer 225b′ is formed on the mirror surface 223b′ of a mirror substrate 221b′, and the mirror surface 223b′ has a shape different from that of the mirror surface 223 of the reflective optical illumination system 100 having no aberrations. That is, the mirror surface 223b′ has a plurality of aberrations. The plurality of aberrations can be understood to be various aberrations as described above, or composite aberrations.

Referring to FIG. 4D, a mirror 220b for correcting the composite aberration in the reflective optical illumination system 100 according to still another embodiment of the present invention is constructed so that expansion aberration correcting parts 250 and contraction aberration correcting parts 260 are formed at various locations in the mirror substrate 221b, thus a mirror surface 223b is coincident with the mirror surface 223 of the reflective optical illumination system 100 having no aberrations. In other words, the mirror surface 223b may be parallel to the mirror surface 223 of the reflective optical illumination system 100 having no aberrations. The expansion aberration correcting parts 250 can be formed at locations which protrude in order to meet the mirror surface 223 of the reflective optical illumination system 100 having no aberrations, whereas the contraction aberration correcting parts 260 can be formed at locations which need to be depressed in order to meet the mirror surface 223. Therefore, the mirror surface 223b′ having an aberration is formed to be coincident with the mirror surface 223 having no aberrations, thus the aberration can be corrected.

FIGS. 5A to 5D are diagrams showing examples in which the technical conception of the present invention is applied to flat mirrors.

FIGS. 5A and 5B are diagrams schematically showing flat mirrors for correcting aberrations in a reflective optical illumination system.

Referring to FIG. 5A, a flat mirror 320′, before the composite aberration in the reflective optical illumination system 100 is corrected, is constructed so that a reflective layer 325a′ is formed on the flat mirror surface 323a′ of a flat mirror substrate 321a′, and the flat mirror surface 323a′ itself has a shape different from that of the surface 323 of the reflective optical illumination system 100 having no aberrations. In detail, the case of FIG. 5A can be understood to be the case where the flat mirror surface 323a′ of the flat mirror 320a′ may have a shape having no aberrations, but, when the reflective optical illumination system 100 has various aberrations, the flat mirror surface 323a′ needs to be changed to the surface 323 of the reflective optical illumination system 100 having no aberrations, and thus the composite aberration in the reflective optical illumination system 100 needs to be corrected.

Referring to FIG. 5B, a flat mirror 320a for correcting the composite aberration in the reflective optical illumination system 100 according to still another embodiment of the present invention is constructed so that expansion aberration correcting parts 350 and contraction aberration correcting parts 360 are formed at various locations in a flat mirror substrate 321a, thus the flat mirror surface 323a is parallel the surface 323 of the reflective optical illumination system 100 having no aberrations In detail, the expansion aberration correcting parts 350, formed in the flat mirror substrate 321a, locally expand the volume of the flat mirror substrate 321a, thus correcting the flat mirror surface 323a′ to make it coincident with the surface 323 of the reflective optical illumination system 100 having no aberrations. The contraction aberration correcting parts 360 locally contract the volume of the flat mirror substrate 321a, thus correcting the flat mirror surface 323a′ to make it coincident with the surface 323 of the reflective optical illumination system 100 having no aberrations.

FIGS. 5C and 5D are diagrams schematically showing a flat mirror especially for correcting its own aberrations.

Referring to FIG. 5C, a mirror 320b′ itself having aberrations has a structure in which a reflective layer 325b′ is formed on the flat mirror surface 323b′ of a flat mirror substrate 321b′, and the flat mirror surface 323b′ has a surface state different from that of a flat mirror surface 323. That is, the flat mirror surface 323b′ has a plurality of aberrations. The aberrations can be understood to be various aberrations, as described above, or composite aberrations.

Referring to FIG. 5D, a flat mirror 320b for correcting an aberration according to still another embodiment of the present invention includes a reflective layer 325b formed on the flat mirror surface 323b of a flat mirror substrate 321b, and a plurality of expansion aberration correcting parts 350 and a plurality of contraction aberration correcting parts 360 formed in the mirror substrate 321b. The expansion aberration correcting parts 350 can be formed at locations which protrude in order to be coincident with the flat mirror surface 323 having no aberrations, and the contraction aberration correcting parts 360 can be formed at locations which need to be depressed. Therefore, the flat mirror surface 223b′ having aberrations is formed to be coincident with the flat mirror surface 323 having no aberrations, thus the aberrations can be corrected.

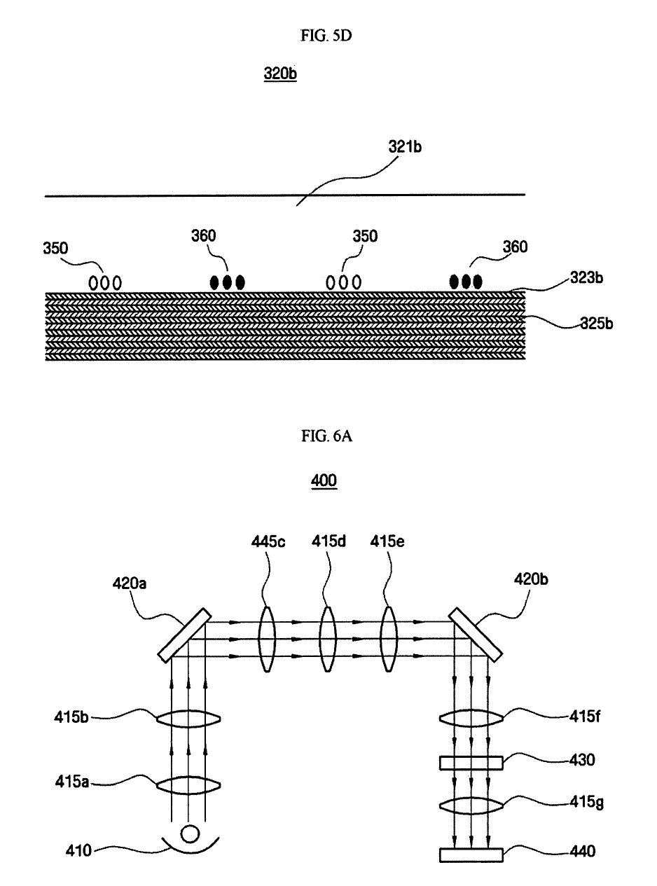

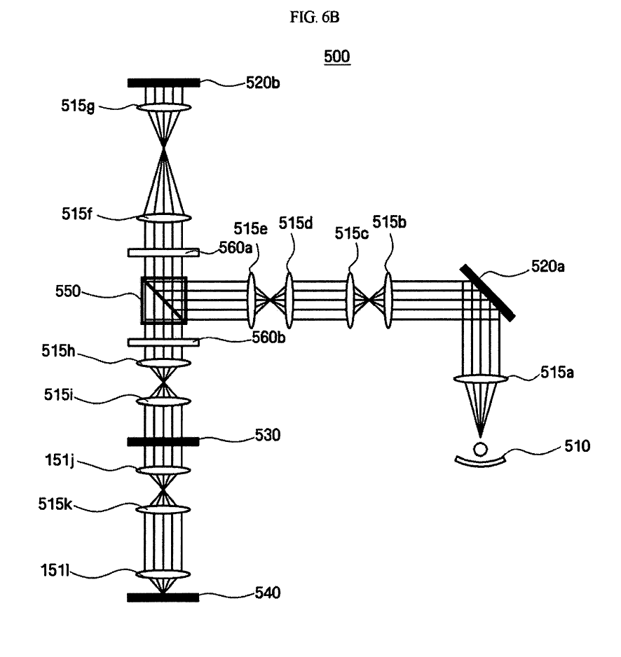

FIGS. 6A and 6B are diagrams schematically showing a transparent optical illumination system for a photolithography apparatus for correcting aberrations according to embodiments of the present invention.

Referring to FIG. 6A, a transparent optical illumination system 400 for a photolithography apparatus for correcting aberrations according to an embodiment of the present invention includes a light source 410, a plurality of lenses 415a to 415g for transmitting light generated by the light source 410, and one or more mirrors 420a and 420b for correcting aberrations in the transparent optical illumination system 400.

The light source 415 generates various light beams used for photolithography. The light source 415 may be, for example, an ArF excimer laser, a KrF excimer laser, an i-line or g-line.

The transparent optical illumination system may further include a transparent photomask 430. The transparent photomask 430 has a substrate made of quartz, and has a shading pattern on a surface of the substrate to block light. The transparent photomask 430 receives light and passes the light through the portions thereof other than the shading pattern, thus forming an optical image.

The lenses 415a to 415g function to transmit light in any one direction, and may be implemented as one of various types depending on respective functions. For example, there are a fly's eye lens, a relay lens, a condenser lens, a projection lens, etc.

One or more mirrors 420a and 420b are included in the transparent optical illumination system 400, and are capable of functioning to change the traveling direction of light. At least one of the mirrors 420a and 420b is a mirror 420a or 420b for correcting aberrations in the transparent optical illumination system 400. The mirror 420a or 420b for correcting aberrations in the transparent optical illumination system 400 includes an aberration correcting part.

The mirror(s) 420a and/or 420b for correcting aberrations in the transparent optical illumination system 400 can be placed in a conjugate plane optically corresponding to a pupil plane.

The projective optical illumination system 400 can independently include the transparent photomask 430, which is placed in the traveling path of light and is adapted to form an optical pattern image, and the pupil plane 440, which receives the optical pattern image and forms a pattern. In the drawing, only flat mirrors 420a and 420b are shown to facilitate the understanding of the technical conception of the present invention, but the mirrors may have a curved surface.

Referring to FIG. 6B, a transparent optical illumination system 500 for a photolithography apparatus for correcting aberrations according to another embodiment of the present invention includes a light source 510, a plurality of lenses 515a to 515l for transmitting light generated by the light source 510 to an image formation surface 540, a mirror 520a for changing the traveling direction of light, a polarization beam splitter 550 having a total reflection or total transmission function according to the polarization characteristic of light, beam polarizing plates 560a and 560b for circularly shifting the phase of light by λ/4, and a mirror 520b for correcting aberrations in the projective optical illumination system 500. The transparent optical illumination system 500 further includes a transparent photomask 530 having an optical pattern. The polarization beam splitter 550 can perform reflection or transmission according to the polarization characteristic of light. In the drawings, light emitted from the light source 510 is reflected and then travels in the direction of the first beam polarizing plate 560a. The light, having passed through the first beam polarizing plate 560a, is incident on and reflected from the mirror 520b for correcting aberrations in the projective optical illumination system 500, with the phase of the light circularly shifted by λ/4. The light reflected from the mirror 520b for correcting aberrations in the transparent optical illumination system 500 passes through the first beam polarizing plate 560a again, and is incident on the polarization beam splitter 550, with the phase thereof circularly shifted by λ/2. The light, the phase of which has been changed, is transmitted through the polarization beam splitter 550. The light, having been transmitted through the polarization beam splitter 550, is incident on the transparent photomask 530 after passing through the lenses 515h and 515i. The optical image, generated after the light has passed through the transparent photomask 530, is projected on the optical image projection surface 540 after passing through the lenses 515j, 515k and 515l.

According to an embodiment of the present invention, the mirror 520b for correcting aberrations in the transparent optical illumination system 500 can be a conjugate plane optically corresponding to the pupil plane.

According to an embodiment of the present invention, the mirror 520b for correcting aberrations in the transparent optical illumination system 500 can be placed at another location, for example, a location at which the traveling direction of light needs to be changed. That is, the mirror 520a for changing the traveling direction of light may also correct aberrations in the transparent optical illumination system 500. In this case, the mirror 520a for changing the traveling direction of light can correspond to the conjugate plane.

Further, according to an embodiment of the present invention, the polarization beam splitter 550 can be applied in various forms. For example, the polarization beam splitter 550 can be implemented in another form in such a way that light emitted from the light source 510 is first totally transmitted through the polarization beam splitter 550, the phase of the transmitted light is circularly shifted, and the transmitted light is reflected from the mirror and is totally reflected from the polarization beam splitter 550. That is, this structure can be understood to be a structure in which the locations of the light source 510 and the optical image projection surface 540 are exchanged, compared to what is shown in the drawing.

The phase of light, having been totally transmitted through the polarization beam splitter 550, can be further changed. In the drawing, the second beam polarizing plate 560b may be further included in the transparent optical illumination system 500. The second beam polarizing plate 560b can stably correct the phase of light having been totally transmitted through the polarization beam splitter 550. That is, additional beam polarizing plates can be included. However, in the transparent optical illumination system 500, as a light path is lengthened and becomes complicated, the intensity of light may diminish, thus the transparent optical illumination system is preferably constructed using simple and fewer components.

A mirror for correcting aberrations in the transparent optical illumination system 500 can also be arranged downstream of the polarization beam splitter 550. For example, the traveling direction of light is changed using a mirror at the subsequent stage of the polarization beam splitter 550, but a mirror for correcting aberrations in the transparent optical illumination system 500 can be adopted as the mirror. In this case, the mirrors must be placed in the conjugate plane, that is, any one of the places at which the traveling of light is indicated by a straight line in the drawing. In the drawing, the places at which the traveling of light is indicated by a straight line substantially corresponding to a conjugate plane. If an aberration cannot be perfectly corrected through a single aberration correcting operation, the aberration in the transparent optical illumination system 500 can be corrected using a plurality of mirrors. In this case, all of the mirrors may be placed in the conjugate plane.

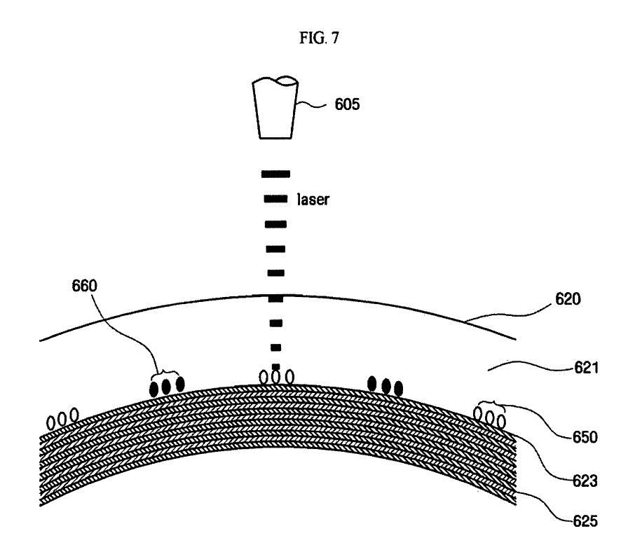

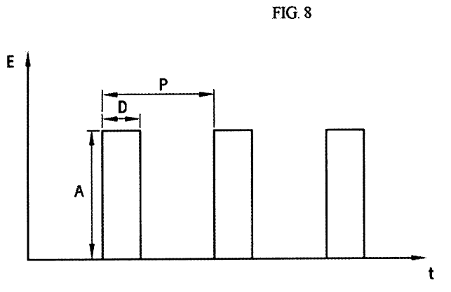

FIG. 7 is a diagram schematically showing a method of forming aberration correcting parts in a mirror substrate according to various embodiments of the present invention.

Referring to FIG. 7, a mirror 620, including aberration correcting parts 650 and 660 in a mirror substrate 621, according to embodiments of the present invention is manufactured in such a way that laser is radiated into the mirror substrate 621 of the mirror 620, which has a reflective layer 625 on one surface 623 thereof, using a laser gun 605 and thus the aberration correcting parts 650 and 660 are formed.

The aberration correcting parts 650 and 660 are formed to be close to the mirror surface 623 on which the reflective layer 625 is formed. In detail, the distance from the aberration correcting parts 650 and 660 to the surface 623 on which the reflective layer 625 is formed in the mirror substrate 621 is shorter than the distance to the surface opposite the surface 623.

The laser is radiated for a time shorter than the thermal diffusion time of the mirror substrate 621, and can be radiated in the form of a pulse. According to an embodiment of the present invention, quartz, exemplified as the material of the mirror substrate 621, has a thermal diffusion time of about several ms per 1 μm. Therefore, if a high energy laser is radiated for a time shorter than the thermal diffusion time, the coupling state of the portion on which the laser is radiated can be changed, without influencing the surrounding region. In other words, it is possible to subject only the portion on which the laser is radiated to expansion stress or contraction stress. A detailed description of the lasing will be made below.

FIG. 8 is a diagram showing a laser for forming aberration correcting parts according to various embodiments of the present invention.

The horizontal axis denotes the time t for which laser is radiated, the vertical axis denotes the energy E of the laser radiation, and the laser is radiated with an intensity A, a pulse duration D, and a pulse pitch P. That is, the laser is radiated at a constant frequency.

The laser used in embodiments of the present invention is radiated with, for example, energy A, pulse duration D, and frequency F. That is, the energy A, the pulse duration D and the frequency F of laser radiation are adjusted, thus various stress generation units can be formed. The pitch P of each pulse can be determined according to frequency F. For example, the pulse duration D can be set to be lower than ½ of the pitch.

The laser used in embodiments of the present invention may be a laser that uses Ti-Sapphire as a light source. In particular, the laser may be a femto-second laser. The technology of the femto-second laser is well known to those skilled in the art, so a detailed description thereof is omitted.

The laser used in embodiments of the present invention can be radiated with energy A of several μJ per pulse, a pulse duration D of several pico-seconds (ps), and a frequency of 100 KHz. These numeric values are only an exemplary implementation of the technical conception of the present invention, and the present invention is not limited to this example. For example, in the present invention, μJ level pulse energy A is used, but a mJ level high energy pulse can be used, or a lower level energy laser can be used. Further, the pulse duration D can be further reduced and can be finely set to a femto-second level.

According to embodiments of the present invention, the expansion aberration correcting parts can be formed by making laser energy A relatively higher than that of contraction aberration correcting parts. For example, the expansion aberration correcting parts can be formed in such a way that a pulse duration D is about 5 to 7 ps, laser energy A is about 3 to 4 μJ, frequency thereof is about 100 KHz, the diameter of the spot of the laser beam is about 1 μm, and the interval at which expansion stress generation units are formed is about 3 μm. Further, the stress generation units can be formed to have a vertical length of about several to several tens of μm and a horizontal length of about 1 μm. However, embodiments can be variously implemented, so embodiments here are only exemplary, and the technical conception of the present invention is not limited thereto.

Further, according to embodiments of the present invention, the contraction aberration correcting parts can be formed in such a way that a pulse duration D is about 1 ps or below, laser energy A is about 1.5 μJ, the frequency of laser radiation and the diameter of the spot of a laser beam are equal to those of the expansion stress generation units, and the interval at which the stress generation units are formed is 1.8 μm. In this case, the contraction aberration correcting parts have a size similar to or smaller than that of the expansion aberration correcting parts.

Corresponding expansion aberration correcting parts can be formed using various methods depending on respective conditions. For example, if laser radiation time is considered, there is a tendency that, as a pulse duration D is lengthened, and as a pitch P is shortened, expansion stress is generated. In contrast, there is a tendency that, as a pulse duration D is shortened, and a pitch P is lengthened, contraction stress is generated. If laser radiation energy A is adjusted, there is a tendency that, as energy increases, expansion stress is generated, whereas, as energy decreases, contraction stress is generated.

There may be more or less sensitive factors among respective process variables depending on the environment of the user intending to implement the technical conception of the present invention. Further, respective stress generation units can also be variously formed depending on the type of equipment to be used, the type of laser, the density of a laser beam, the profile of a laser beam, etc. Therefore, all of the concrete numeric values proposed in the present specification are only exemplary, and should not be understood to limit the scope of the present invention.

As described above, the photolithography apparatus and mirror according to embodiments of the present invention can immediately correct aberrations, so that a precise photolithography process can be performed depending on the characteristics of each process and environmental characteristics, and an optical illumination system having aberrations can be corrected. Therefore, the present invention can help realize a fine photolithography process, and extend the lifespan of the photolithography apparatus, thus improving productivity and decreasing the manufacturing cost of products.

Although preferred embodiments of the present invention have been disclosed for illustrative purposes, those skilled in the art will appreciate that various modifications, additions and substitutions are possible, without departing from the scope and conception of the invention.

What is claimed is:

1. A photolithography apparatus, comprising:
an optical illumination system comprising,
a light source generating light,
an illumination system transmitting the light generated by the light source,
a photomask receiving the light transmitted by the illumination system and forming an optical pattern image, and
a projection system transmitting the optical pattern image formed by the photomask to a pupil plane; and
at least one mirror correcting an aberration in the optical illumination system.

2. The photolithography apparatus of claim 1, wherein the mirror is included in the illumination system.

3. The photolithography apparatus of claim 1, wherein the mirror is placed in a conjugate plane optically corresponding to the pupil plane.

4. The photolithography apparatus of claim 1, wherein the mirror comprises an aberration correcting part formed therein.

5. The photolithography apparatus of claim 4, wherein the aberration correcting part generates stress expanding a volume of the mirror.

6. The photolithography apparatus of claim 5, wherein the expansion of the volume of the mirror locally decreases a density of the mirror.

7. The photolithography apparatus of claim 4, wherein the aberration correcting part generates stress contracting a volume of the mirror.

8. The photolithography apparatus of claim 7, wherein the contraction of the volume of the mirror locally increases a density of the mirror.

9. The photolithography apparatus of claim 4, wherein the aberration correcting part is spaced apart from a central surface of a mirror substrate to be closer to a surface of the mirror substrate on which a reflective layer is formed.

10. The photolithography apparatus of claim 4, wherein the aberration correcting part is formed by radiating a pulse-shaped laser.

11. The photolithography apparatus of claim 1, wherein either one of the illumination system and the projection system of the optical illumination system comprises at least one optical lens.

12. The photolithography apparatus of claim 1, wherein the optical illumination system further comprises a beam polarizing plate receiving light, and transmitting the light there through while circularly shifting a phase of the light.

13. The photolithography apparatus of claim 12, wherein the optical illumination system further comprises a beam splitter reflecting first polarized light, and transmitting second polarized light.

14. The photolithography apparatus of claim 13, wherein the first polarized light and the second polarized light have a circular phase difference of λ/2 there between.

15. A photolithography apparatus, comprising:
an optical illumination system comprising,
a light source;
a plurality of lenses transmitting light generated by the light source, and
a plurality of mirrors changing a traveling direction of the light generated by the light
source; and
at least one mirror correcting an aberration of the optical illumination system.

16. The photolithography apparatus of claim 15, wherein the mirror, correcting the aberration in the optical illumination system, is placed in a conjugate plane optically corresponding to a pupil plane.

17. The photolithography apparatus of claim 15, wherein the mirror, correcting the aberration in the optical illumination system, comprises an aberration correcting part formed in the mirror.

18. The photolithography apparatus of claim 17, wherein the aberration correcting part generates stress changing a volume of the mirror, correcting the aberration in the optical illumination system.

19. The photolithography apparatus of claim 18, wherein the stress is generated while a density of the mirror, correcting the aberration in the optical illumination system, locally changes.

20. The photolithography apparatus of claim 19, wherein the stress expands the volume of the mirror, correcting the aberration in the optical illumination system, and is generated while a density of the mirror, correcting the aberration in the optical illumination system, locally decreases.

21. The photolithography apparatus of claim 19, wherein the stress contracts the volume of the mirror, correcting the aberration in the optical illumination system, and is generated while a density of the mirror, correcting the aberration in the optical illumination system, locally increases.

22. The photolithography apparatus of claim 17, wherein the aberration correcting part is spaced apart from a central surface of the mirror, correcting the aberration in the optical illumination system, to be closer to a surface of the mirror on which a reflective layer is formed.

23. A mirror, comprising:
a substrate;
a reflective layer formed on one surface of the substrate; and
an aberration correcting part formed in the substrate.

24. The mirror of claim 23, wherein the substrate comprises quartz, and the reflective layer comprises a plurality of material layers that are alternately stacked with each other.

25. The mirror of claim 24, wherein the material layers comprise a silicon layer and a molybdenum layer.

26. The mirror of claim 23, wherein the aberration correcting part generates stress expanding a volume of the substrate.

27. The mirror of claim 26, wherein the aberration correcting part locally decreases a density of the substrate.

28. The mirror of claim 23, wherein the aberration correcting part generates stress contracting a volume of the substrate.

29. The mirror of claim 28, wherein the aberration correcting part locally increases a density of the substrate.

30. The mirror of claim 23, wherein the aberration correcting part is spaced apart from a central surface of the substrate to be closer to a surface of the substrate on which a reflective layer is formed.
